(19) United States
(12) Patent Application Publication
(10) Pub. No.: US 2012/0216033 A1
(43) Pub. Date: Aug. 23, 2012

(54) COMMUNICATION SYSTEM, PRINTING DEVICE, AND SA ESTABLISHMENT METHOD

(75) Inventors: Hideaki OGATA, Yokohama-shi (JP); Yoichi TAKAHASHI, Shiojiri-shi (JP)

(73) Assignee: SEIKO EPSON CORPORATION, Tokyo (JP)

(21) Appl. No.: 13/397,559

(22) Filed: Feb. 15, 2012

(30) Foreign Application Priority Data
Feb. 17, 2011 (JP) 2011-031720
Feb. 23, 2011 (JP) 2011-036815

(51) Int. Cl. H04L 29/06

(52) U.S. Cl. 713/151

(57) ABSTRACT

A communication system includes an SA parameter exchanging portion that builds and deletes SA, and a nonvolatile storage portion that stores at least a part of information for the SA parameter set, wherein, in a case where a printing device is initialized, the printing device has a message transmission portion that transmits a predetermined message to a communication device if a part of information is stored in a nonvolatile storage portion, and the communication device deletes information for performing IPsec communication with the printing device from a nonvolatile storage portion of the communication device in response to reception of the predetermined message.

### BACKGROUND

1. Technical Field

The present invention relates to a communication system, a printing device, and an SA establishment method, and more particularly to a communication system, a printing device, and an SA establishment method which can be appropriately used for IPsec communication between a personal computer and a printer.

2. Related Art

When intercommunication is performed between an Internet communication system in the related art including a communication device such as a personal computer and a printing device, IPsec communication, which is an example of the secure IP communication, is used. The IPsec communication is advantageous in that security related methods such as encryption, electronic signature, and authentication can be used without changing the upper-layer protocol in order to prevent menaces such as eavesdropping, falsification, impersonation, and denial. In order to realize secure IP communication, in IPsec communication, three protocols called AH (IP Authentication Header), ESP (IP Encryption Payload), and IKE (Internet Key Exchange), SA (Security Association) which have a meaning as a link or a secure virtual communication path for managing keys or using secure protocols, and techniques such as authentication and encryption algorithms, are used. In addition, in a printing device in the related art, when communicating with the other party communication device such as an external personal computer, the IPsec communication, which is an example of the secure IP communication, is used.

As shown in FIG. 9, when a printing device 101 in the related art performs the IPsec communication with a communication device 110, the printing device uses the IKE protocol in order to generate SA (time T100 to time T101: exchange of IKE SA parameters). The reason why the IKE protocol is used is that generation, exchange, and update of keys of both an authentication session key (HMAC) and an encryption session key are automatically performed.

The generation steps of the SA using the IKE include two steps of a phase 1 and a phase 2. In the phase 1, ISAKMP_SA is generated by interchanging ISAKMP_SA parameter sets which are a group of ISAKMP_SA parameters between the communication device 110 which is an SA transmission side (initiator) and the printing device 101 which is an SA reception side (responder). In addition, in the phase 2, IPsec_SA called SA is generated by interchanging an IPsec_SA parameter set which is a group of IPsec_SA parameters including a key used for encryption or authentication, using the ISAKMP_SA generated in the phase 1.

If transmission and reception of IPsec packets are performed using the IPsec_SA, it is possible to realize secure communication of printing related data (time T101 to time T102: secure communication).

In addition, in FIG. 9, secure communication using the ISAKMP_SA is visually represented by the transparent transversely long cylinder vr1, and secure communication using the IPsec_SA is visually represented by the transparent transversely long cylinder vr2.

In addition, in order to increase safety of the IPsec communication, the term of validity is provided in the SA (time T100 to time T104: the term of SA validity). In a case where the term of validity has expired, the SA parameter set used hitherto is mutually deleted (time T104 to time T105: during deletion of old SA), the encryption key included in the IPsec_SA parameter set is reset, and thereby the communication device 110 and the printing device 101 in the related art automatically rebuild SA (time T105 to time T106: exchange of IKE_SA parameters (SA rebuilding)).

Here, although not shown, even before the term of validity is expired, when either the communication device 110 or the printing device 101 in the related art is normally finished or reactivated, one device which is normally finished or reactivated transmits an activation message to the other device so as to mutually delete the SA used hitherto, thereby preventing reuse of SA which is a factor which reduces the safety of the IPsec communication (refer to the Related Art of JP-A-2009-219106).

However, in the printing device 101 in the related art, in a case where the printing device 101 is not normally finished but abruptly finishes due to a power failure (time T102: abrupt finish of the printing device 101), even if the printing device 101 is immediately reactivated (time T103: reactivation of the printing device 101), there is a problem in that the IPsec communication may not be promptly restarted (time T102 to time T105: disable of IPsec communication).

This problem occurs because, since the SA parameter set of the communication device 110 is not deleted although the SA parameter set of the printing device 101 is deleted due to the abrupt finish of the printing device 101 (time T102 to time T103: power failure to the printing device 101), the communication device 110 successively sends the SA parameter set to the printing device 101 in order to recover the IPsec communication until the term of validity of the SA parameter set of the communication device 110 is expired (time T103 to time T104: transmission of the SA parameters of the communication device 110).

In order to promptly restart the IPsec communication, preferably, an SA deletion parameter set or the other party IP address necessary to delete the SA from the SA parameter set is selected, and an SA deletion notifying message or an activation message which is created based on the SA deletion parameter set or the other party IP address is transmitted to the communication device 110 from the printing device 101. However, the SA parameter set disappears when the printing device 101 is suddenly finished, and thus the activation message may not be created after the printing device 101 is reactivated.

### SUMMARY

Therefore, an advantage of some aspects of the invention is to enable IPsec communication to be promptly restarted after an SA parameter set disappears.

According to an aspect of the invention, there is provided a communication system having a communication device and a printing device performing IPsec communication, wherein both the devices include an SA parameter exchanging portion that builds and deletes SA (Security Association) which is a secure virtual communication path by exchanging SA parameter sets which are various parameters for performing the IPsec communication with the other party device; and a nonvolatile storage portion that stores at least a part of information for the SA parameter set, wherein, in a case where the printing device is initialized, the printing device has a message transmission portion that transmits a predetermined message to the communication device if the part of information is stored in the nonvolatile storage portion, and the communication device deletes information for performing the IPsec communication with the printing device from the nonvolatile storage portion of the communication device in response to reception of the predetermined message.

Thereby, even if the printing device is suddenly finished due to a power failure, it is possible to delete an SA parameter set of the communication device when the printing device is reactivated.

The part of information stored in the nonvolatile storage portion of the printing device may include an IP address of the communication device included in an SA parameter set, and an SA deletion parameter set used to delete the SA, and, if the SA deletion parameter set is stored in the nonvolatile storage portion of the printing device, the message transmission portion of the printing device may create an SA deletion notifying message for requesting deletion of the SA based on the SA deletion parameter set, and transmit the SA deletion notifying message to the communication device as the predetermined message.

Thereby, it is possible to transmit the activation message using a simple communication protocol instead of the IPsec communication. In addition, it is possible to realize transmission of the SA deletion notifying message and suppress a volume necessary for preservation in the nonvolatile storage portion to the minimum by restricting a parameter set preserved in the nonvolatile storage portion to the SA deletion parameter set.

The SA deletion parameter set may include at least the other party IP address, an ISAKMP_SA identifier, an encryption algorithm, and an encryption key, which are ISAKMP_SA parameters, and an IPsec_SA identifier which is an IPsec_SA parameter.

Thereby, it is possible to realize transmission of the SA deletion notifying message and suppress a volume necessary for preservation in the nonvolatile storage portion to the minimum by restricting a parameter set preserved in the nonvolatile storage portion to the SA deletion parameter set.

The printing device may further include an SA deletion parameter deleting portion that deletes the SA deletion parameter set from the nonvolatile storage portion of the printing device after the SA deletion notifying message is transmitted.

Thereby, it is possible to prevent unnecessary SA deletion parameter sets from being accumulated in the nonvolatile storage portion.

The part of information stored in the nonvolatile storage portion of the printing device may include an IP address of the communication device included in an SA parameter set, and, if an IP address of the communication device is stored in the nonvolatile storage unit of the printing device, the message transmission portion of the printing device may create an activation message including the IP address of the communication device stored in the nonvolatile storage portion and an IP address of the printing device, and transmit the activation message to the communication device as a predetermined message.

Thereby, an IP address of the communication device is stored in the nonvolatile storage portion of the printing device, and an agent of the communication device is used, thereby deleting an SA parameter set of the communication device when the printing device is reactivated even if the printing device is suddenly finished due to a power failure.

The communication device may further include an SA parameter deletion portion (agent) that deletes the SA parameter set related to the IPsec communication with the printing device in response to reception of the activation message.

Thereby, an IP address of the communication device is stored in the nonvolatile storage portion of the printing device, and an agent of the communication device is used, thereby deleting an SA parameter set of the communication device when the printing device is reactivated even if the printing device is suddenly finished due to a power failure.

The printing device may further include an IP address deletion portion that deletes the IP address of the communication device from the nonvolatile storage portion of the printing device after transmitting the activation message.

Thereby, an IP address of the communication device is stored in the nonvolatile storage portion of the printing device, and an agent of the communication device is used, thereby deleting an SA parameter set of the communication device when the printing device is reactivated even if the printing device is suddenly finished due to a power failure.

According to another aspect of the invention, there is provided a printing device which performs IPsec communication with a communication device, including an SA parameter exchanging portion that builds and deletes SA (Security Association) which is a secure virtual communication path by exchanging SA parameter sets which are various parameters for performing the IPsec communication with the communication device; and a nonvolatile storage portion that stores at least a part of information for the SA parameter set, wherein, in a case where the printing device is initialized, the printing device has a message transmission portion that transmits a predetermined message to the communication device so as to request the communication device to delete information of the communication device for performing the IPsec communication if the part of information is stored in the nonvolatile storage portion.

Thereby, even if the printing device is suddenly finished due to a power failure, it is possible to delete an SA parameter set of the communication device when the printing device is reactivated.

According to still another aspect of the invention, there is provided an SA establishment method for establishing SA (Security Association) which is a secure virtual communication path in order to perform IPsec communication between a communication device and a printing device, wherein both the communication device and the printing device exchange SA parameter sets which are various parameters for performing IPsec communication with other party device, and respectively include a nonvolatile storage portion that stores at least a part of information for the SA parameter set, the method including determining whether or not the part of information is stored in the nonvolatile storage portion of the printing device if the printing device is initialized; transmitting a predetermined message to the communication device if it is determined that the part of information is stored; determining whether or not the communication device receives the predetermined message; and deleting information for performing the IPsec communication with the printing device from the nonvolatile storage portion of the communication device according to a determination that the communication device receives the predetermined message.

Thereby, even if the printing device is suddenly finished due to a power failure, it is possible to delete an SA parameter set of the communication device when the printing device is reactivated.

### BRIEF DESCRIPTION OF THE DRAWINGS

The invention will be described with reference to the accompanying drawings, wherein like numbers reference like elements.

FIG. 1 is a block diagram illustrating a configuration of the printing device of the Internet communication system according to an embodiment of the invention.

FIG. 2 is a sequence diagram illustrating communication procedures of the Internet communication system according to the embodiment.

FIG. 3 is a flowchart illustrating IPsec communication start procedures in the Internet communication system according to the embodiment.

FIG. 4 is a flowchart illustrating IPsec communication end procedures in the Internet communication system according to the embodiment.

FIG. 5 is a block diagram illustrating a configuration of the printing device according to an embodiment of the invention.

FIG. 6 is a sequence diagram illustrating communication procedures between the printing device according to the embodiment and the other party communication device.

FIG. 7 a flowchart illustrating process procedures regarding preserving of an SA deletion parameter set in the printing device according to the embodiment.

FIG. 8 is a flowchart illustrating procedures regarding SA deletion processes in the printing device according to the embodiment.

FIG. 9 is a sequence diagram illustrating communication procedures between the printing device in the related art and the other party communication device.

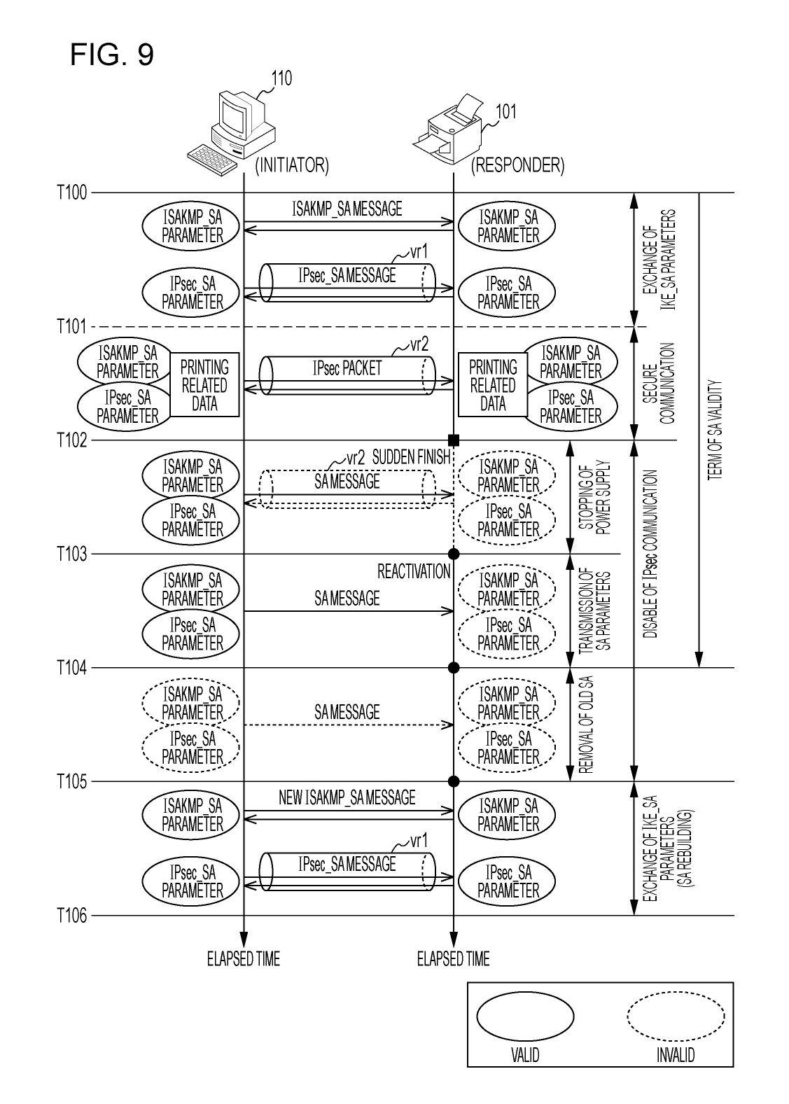

### DESCRIPTION OF EXEMPLARY EMBODIMENTS

Hereinafter, a communication system, a printing device, and an SA establishment method according to a first embodiment of the invention will be described.

First, a communication system according to the first embodiment will now be described.

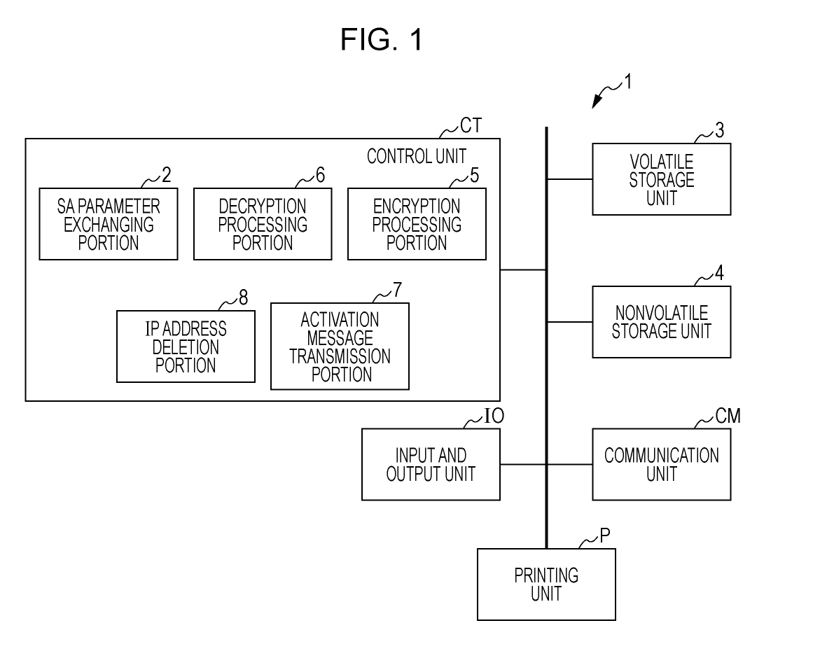

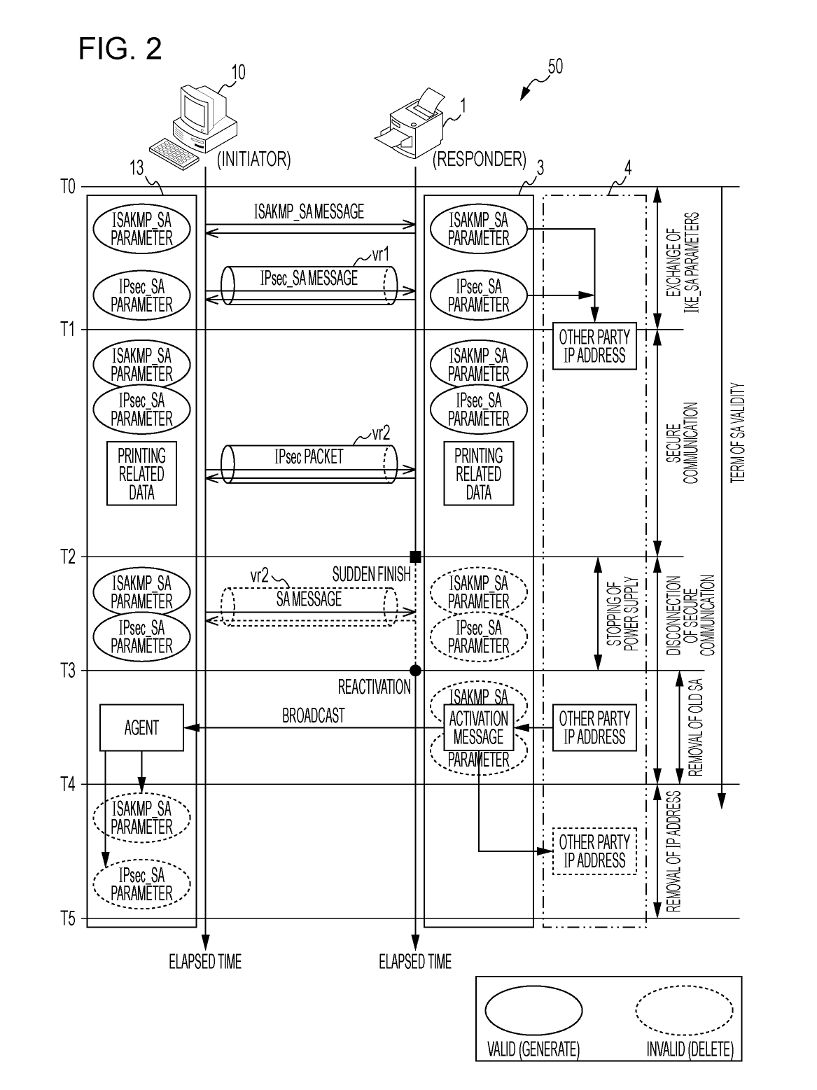

FIG. 1 is a block diagram illustrating a configuration of the printing device 1 related to the Internet communication system according to the first embodiment. In addition, FIG. 2 is a sequence diagram illustrating communication procedures of the Internet communication system according to the first embodiment.

The Internet communication system 50 according to the first embodiment includes a communication device 10 which is a first communication portion and the printing device 1 which is a second communication portion as shown in FIG. 2. In addition, here, although the following embodiments will be described by exemplifying the printing device as a peripheral device, the invention is applicable to peripheral devices other than the printing device.

The communication device 10 according to the first embodiment is a device where an agent is resident in a personal computer capable of performing IPsec communication. In the communication device 10, although not shown, a processing unit such as a CPU, a storage unit such as an HDD or a memory, a communication unit performing Internet communication using a WAN or a LAN, and an input and output unit performing manual input or input and output of various signals, are electrically connected to each other.

The communication device 10 may be a host device of the printing device 1. For example, the communication device 10 may include a driver driving the printing device 1 and transmits a printing command to the printing device 1 so as to perform printing.

Here, the agent indicates a program or the like which performs management and monitoring of network apparatuses and collection of management information regarding them. An example of the agent may include an SNMP (Simple Network Management Protocol) which manages a server or a router over a network. The agent may be included in the above-described driver driving the printing device 1.

The agent according to the first embodiment is programmed so as to delete an SA parameter set related to the IPsec communication from the storage unit provided in the communication device 10, in response to reception of an activation message transmitted from the printing device. For example, if the received activation message includes an

IP address of the self device (the communication device 10), the agent specifies an IP address of the device (for example, the printing device 1) which has issued the activation message. In addition, the agent deletes the SA parameter set related to the IPsec communication which is established with the device having issued the activation message. In the first embodiment, the agent works in the most effective manner when deleting the SA parameter set related to the IPsec communication which was performed before abrupt finish of the printing device at the time of reactivation after the printing device is suddenly shutdown (finished).

The printing device 1 according to the first embodiment includes, as shown in FIG. 1, a printing unit P of an ink jet, a printer, a header, and the like, a control unit CT such as a CPU controlling the printing unit, a volatile storage unit 3 such as a volatile memory, a nonvolatile storage unit 4 such as a nonvolatile memory, a communication unit CM which performs communication using a WAN, a LAN, or the like, and an input and output unit IO which performs manual input or input and output of various signals. The control unit CT realizes a plurality of portions described below by executing a predetermined computer program. In other words, the control unit CT includes an SA parameter exchanging portion 2, an encryption processing portion 5, a decryption processing portion 6, an activation message transmission portion 7, and an IP address deletion portion 8.

The SA parameter exchanging portion 2 builds and deletes SA (Security Association) by interchanging SA parameter sets and is the same as the SA generation portion provided in the printing device 101 in the related art.

In the same manner as the related art, in the IPsec communication, three protocols called AH (IP Authentication Header), ESP (IP Encryption Payload), and IKE (Internet Key Exchange), SA (Security Association) which has a meaning as a link or a secure virtual communication path for managing a key or using a secure protocol, authentication, and encryption algorithm, are used.

In addition, in the same manner as the related art, generation steps of the SA using the IKE include two steps of a phase 1 where ISAKMP_SA is generated and a phase 2 where IPsec_SA is generated.

In addition, the SA parameter set includes various parameters for performing secure communication using the IPsec communication with the communication device 10. Examples of the SA parameters include an SPI (Security Parameter Index), a sequence number counter, an overflow flag, a replay prevention window, an ESP encryption algorithm, an AH/ESP authentication algorithm, an encryption key, the term of SA validity, an IPsec mode (a transport mode or a tunnel mode), a stateful fragment check flag, a bypass DF bit, Path_MTU, DSCP, bypass DSCP, a tunnel mode start address, a tunnel mode end address, and the like.

Here, an IP address of the other party (hereinafter, referred to as the “other party IP address”) and an IP address of the printing device 1 (hereinafter, referred to as a “self IP address”) are given as IP headers before the payload and the AH/ESP header when the IPsec mode is fragmented. In relation to the encryption algorithm, an existing encryption algorithm is preferably designated using an identifier or the like rather than the algorithm itself being included as a parameter. For this reason, in a case where the encryption algorithm is designated as an SA parameter, an identifier specifying the encryption algorithm may be used as an SA parameter. In addition, an initiator cookie or a responder cookie is included in the ISAKMP_SA header of the initiator side or the responder side.

The volatile storage unit 3 temporarily stores the SA parameter set. In other words, the SA parameter set stored in the volatile storage unit 3 is automatically deleted when the printing device 1 is finished.

The nonvolatile storage unit 4 permanently stores the other party IP address. The other party IP address is extracted from the SA parameter set which is obtained during the IPsec communication.

The encryption processing portion 5 encrypts the other party IP address. The encryption process is performed after the other party IP address is created and before the other party IP address is stored. In addition, an encryption algorithm used for the encryption process uses an algorithm different from the encryption algorithm related to the SA parameter set. A specific example of the encryption process method includes an encrypting file system (EFS).

In a case where the other party IP address stored in the nonvolatile storage unit 4 has been encrypted, the decryption processing portion 6 decrypts the other party IP address before creating an activation message. A decryption process method is preferably selected based on the encryption process method. In addition, the encryption processing portion 5 and the decryption processing portion 6 may be omitted.

The activation message transmission portion 7 transmits an activation message created based on the self IP address which is automatically acquired and the other party IP address stored in the nonvolatile storage unit 4.

The activation message is a message which is transmitted before new SA is rebuilt such that the SA parameter exchanging portion 2 requests the communication device 10 to delete the SA before the rebuilding. The activation message is transmitted, for example, in a case where an SA parameter set is not stored in the volatile storage unit 3 and the other party IP address is stored in the nonvolatile storage unit 4 when the printing device 1 is reactivated after being suddenly finished.

In addition, the activation message is transmitted by the activation message transmission portion 7 using a protocol different from the IPsec. For example, the activation message transmission portion 7 may transmit the activation message as broadcast using TCP or UDP.

The IP address deletion portion 8 deletes the other party IP address before the SA is rebuilt, from the nonvolatile storage unit 4. The IP address deletion portion deletes the other party IP address after the activation message transmission portion 7 transmits the activation message.

Next, a deletion method of the SA parameter set and a deletion program of the SA parameter set will be described.

A deletion program of the SA parameter set according to the first embodiment is installed in the communication device 10 and the printing device 1 constituting the Internet communication system 50 according to the first embodiment. The deletion program of the SA parameter set is a program which enables the Internet communication system 50 to execute a nonvolatile storage procedure, an activation message transmission procedure, an SA parameter set deletion procedure, and an IP address deletion procedure. Through the execution of the deletion program of the SA parameter set, there is realization of a deletion method of the SA parameter set which mainly includes a nonvolatile storage step, an activation message transmission step, an SA parameter set deletion step, and an IP address deletion step, which are the same contents as the procedures of the deletion program of the SA parameter set.

The deletion method of the SA parameter set according to the first embodiment includes an SA building step, a first storage step, an encryption process step, a second storage step which is a nonvolatile storage step, a decryption process step, an activation message transmission step, an SA parameter deletion step, and an IP address deletion step.

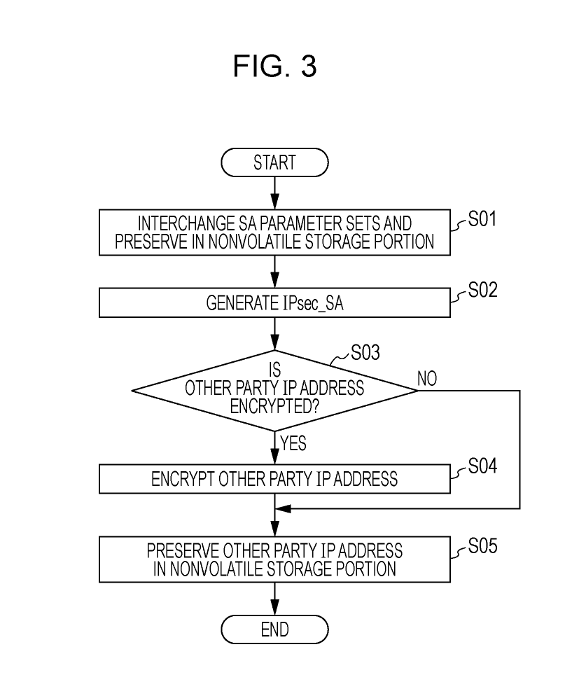

First, an IPsec communication start procedure in the Internet communication system 50 according to the first embodiment will be described with reference to FIGS. 2 and 3. In FIG. 2, secure communication using the ISAKMP_SA is visually represented by the transparent transversely long cylinder denoted by the reference numeral vr1, and secure communication using the IPsec_SA is visually represented by the transparent transversely long cylinder denoted by the reference numeral vr2.

In the SA building step, as shown in FIGS. 2 and 3, SA is built between the communication device 10 and the printing device 1 by interchanging SA parameter sets (time T0 to time T1 in FIG. 2: exchange of IKE_SA parameters, and S01 to S02 in FIG. 3). In the same manner as the related art, the SA has the ISAKMP_SA of the phase 1 and the IPsec_SA of the phase 2, and the SA is established in this order.

In the first storage step, as shown in FIGS. 2 and 3, the SA parameter sets exchanged in the SA building step are temporarily stored in the respective volatile storage units 13 and 3 provided in the communication device 10 and the printing device 1 (time T0 to time T1 in FIG. 2: exchange of IKE_SA parameters, and S01 in FIG. 3).

In the encryption process step, the other party IP address is encrypted (S03 and S04 in FIG. 3). The encryption is performed after the other party IP address is created and before the other party IP address is stored. In addition, as shown in FIG. 3, if the encryption processing portion 5 is not installed in the printing device 1, the encryption process may not be performed (S03 to S05 in FIG. 3).

In the second storage step (nonvolatile storage step), as shown in FIGS. 2 and 3, the other party IP address is permanently stored in the nonvolatile storage unit 4 of the printing device 1 (time T1 in FIG. 2, and S05 in FIG. 3).

If the IPsec_SA is generated, as shown in FIG. 2, printing related data is transmitted and received between the communication device 10 and the printing device 1 using IPsec packets via the IPsec_SA (time T1 to time T2: secure communication).

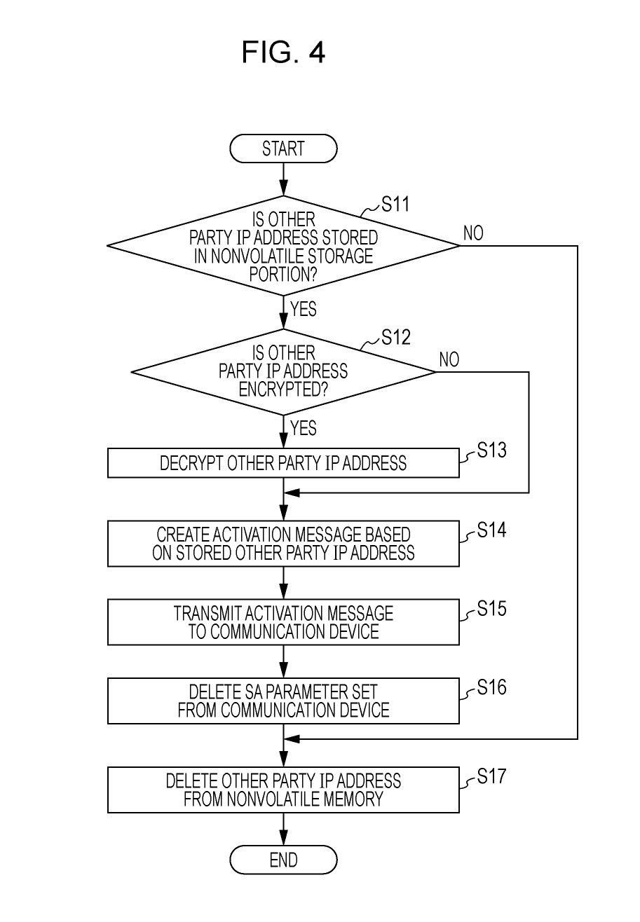

Next, referring to FIGS. 2 and 4, there will be made a description of a procedure where the SA parameter set of the communication device 10 is deleted when the SA parameter set of the printing device 1 disappears in the Internet communication system 50 according to the first embodiment. The process flow shown in FIG. 4 is performed, for example, during an initialization process for initializing the printing device 1.

As shown in FIG. 2, in a case where the printing device 1 is suddenly shutdown (finished) due to a certain unexpected cause such as a power failure during the IPsec communication (time T2), the SA parameter set stored in the volatile storage unit 3 of the printing device 1 is deleted, and thus the IPsec communication is disconnected (time T2 to time T3: power failure). For this reason, as shown in FIG. 2, when the printing device 1 is reactivated (time T3), it is checked whether or not the other party IP address is stored in the nonvolatile storage unit 4 as shown in FIG. 4 (S11).

In the decryption process step, as shown in FIG. 4, if the other party IP address is encrypted, the decryption process is performed for the other party IP address (S12 and S13).

In the activation message transmission step, as shown in FIGS. 2 and 4, the activation message transmission portion 7 creates an activation message based on the other party IP address stored in the nonvolatile storage unit 4 and the self IP address which is automatically acquired (S14). In addition, the created activation message is transmitted to the communication device 10 from the printing device 1 (S15, and time T3 to time T4 in FIG. 2: removal of old SA). At this time, the activation message is transmitted using the broadcast.

In the SA parameter set deletion step, as shown in FIGS. 2 and 4, if the agent of the communication device 10 receives the activation message, the agent deletes the SA parameter set from the storage unit 13 of the communication device 10 (time T3 to time T4 in FIG. 2: removal of old SA, and S16 in FIG. 4).

In the IP address deletion step, as shown in Figs. and 4, the IP address deletion portion 8 transmits the activation message and then deletes the other party IP address from the nonvolatile storage unit 4 (time T4 to time T5 in FIG. 2: removal of the other party IP address, and S17 in FIG. 4).

Thereby, the SA parameter set is deleted from the storage unit 13 of the communication device 10, and thus it is possible to promptly start rebuilding of SA between the printing device 1 and the communication device 10.

Through the above-described steps, the deletion method of the SA parameter set is realized based on the deletion program of the SA parameter set according to the first embodiment.

Next, there will be made a description of operations and effects of the Internet communication system 50, the deletion method of the SA parameter set, and the deletion program of the SA parameter set according to the first embodiment.

In the Internet communication system 50 according to the first embodiment, an IP address of the communication device 10 (the other party IP address) is stored in the nonvolatile storage unit 4 of the printing device 1, and the agent installed in the communication device 10 manages and monitors the network, thereby deleting the SA parameter set of the communication device 10 when the printing device 1 is reactivated even if the printing device 1 is suddenly finished due to a power failure.

In addition, the operations and effects of the deletion method of the SA parameter set and the deletion program of the SA parameter set according to the first embodiment are realized by the Internet communication system 50 according to the first embodiment, and are thus the same as the operations and effects of the Internet communication system 50 according to the first embodiment.

That is to say, according to the Internet communication system, the deletion method of the SA parameter set, and the deletion program of the SA parameter set in the first embodiment, even if the printing device which is the second communication portion is suddenly finished due to a power failure, an SA parameter set of the communication device which is the first communication portion such as a personal computer can be deleted when the printing device is reactivated, and thus there is an achievement of the effect that the IPsec communication can be promptly restarted in the Internet communication system.

Here, the invention is not limited to the above-described embodiment and can be variously modified as necessary.

Hereinafter, a second embodiment will be described. First, a printing device 1 according to the embodiment will now be described.

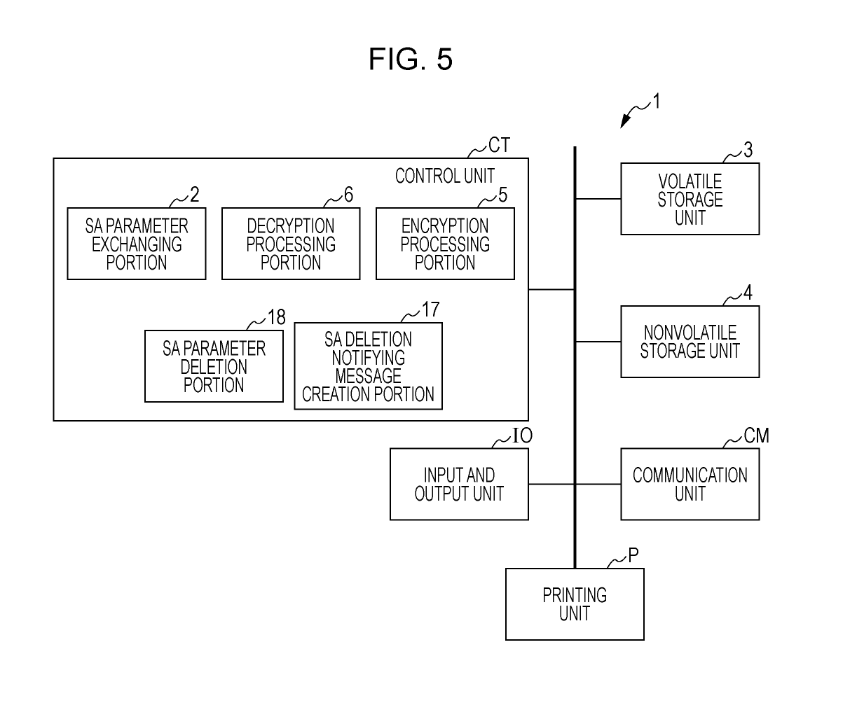

The printing device 1 according to the second embodiment includes, as shown in FIG. 5, a printing unit P of an ink jet, a printer, a header, and the like, a control unit CT such as a CPU controlling the printing unit, a volatile storage unit 3 such as a volatile memory, a nonvolatile storage unit 4 such as a nonvolatile memory, a communication unit CM which performs communication using a WAN, a LAN, or the like, and an input and output unit IO which performs manual input or input and output of various signals. The control unit CT realizes a plurality of portions described below by executing a predetermined computer program. In other words, the control unit CT includes an SA parameter exchanging portion 2, an encryption processing portion 5, a decryption processing portion 6, an SA deletion notifying message creation portion 17, and an SA parameter deletion portion 18.

The SA parameter exchanging portion 2 builds and deletes SA (Security Association) by interchanging SA parameter sets and is the same as the SA generation portion provided in the printing device 101 in the related art.

In the same manner as the related art, in the IPsec communication, three protocols called AH (IP Authentication Header), ESP (IP Encryption Payload), and IKE (Internet Key Exchange), SA (Security Association) which has a meaning as a link or a secure virtual communication path for managing a key or using a secure protocol, authentication, and encryption algorithm, are used.

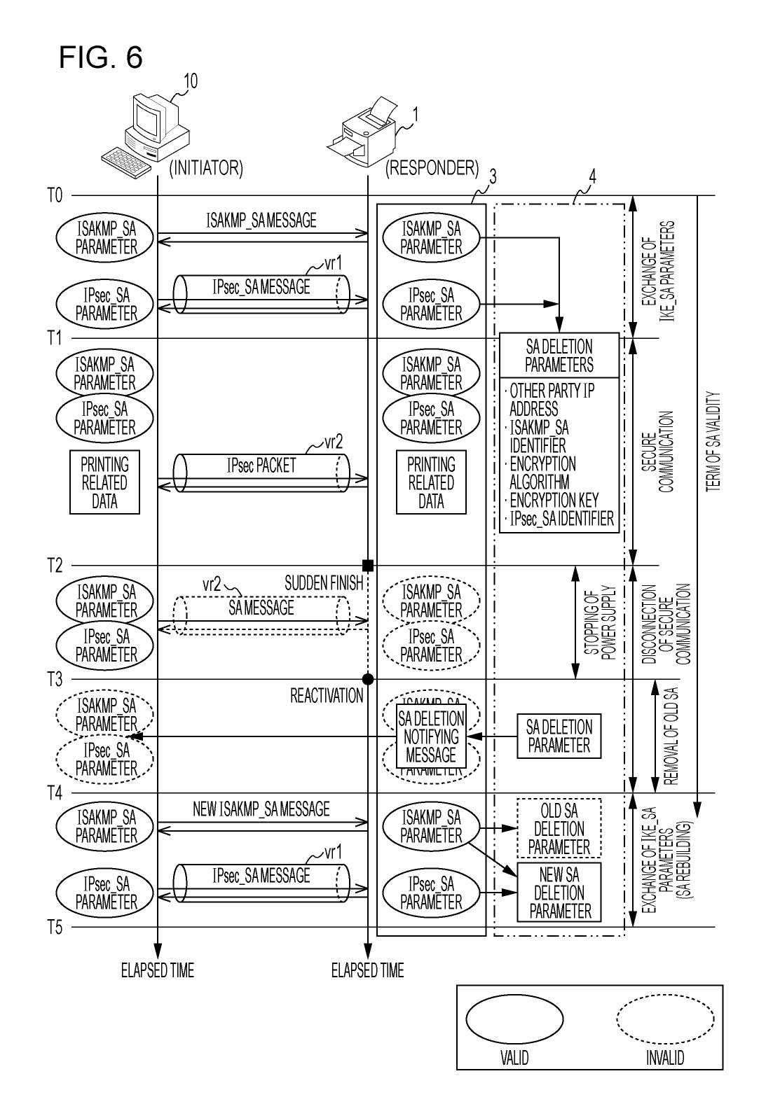

In addition, in the same manner as the related art, generation steps of the SA using the IKE include two steps of a phase 1 where ISAKMP_SA is generated and a phase 2 where IPsec_SA is generated. In FIG. 6, secure communication using the ISAKMP_SA is visually represented by the transparent transversely long cylinder denoted by the reference numeral vr1, and secure communication using the IPsec_SA is visually represented by the transparent transversely long cylinder denoted by the reference numeral vr2.

In addition, the SA parameter set includes various parameters for performing secure communication using the IPsec communication with the communication device 10. Examples of the SA parameters include an SPI (Security Parameter Index), a sequence number counter, an overflow flag, a replay prevention window, an ESP encryption algorithm, an AH/ESP authentication algorithm, an encryption key, the term of SA validity, an IPsec mode (a transport mode or a tunnel mode), a stateful fragment check flag, a bypass DF bit, Path_MTU, DSCP, bypass DSCP, a tunnel mode start address, a tunnel mode end address, and the like.

Here, an IP address of the other party (hereinafter, referred to as the “other party IP address”) and an IP address of the printing device 1 are given as IP headers before the payload and the AH/ESP header when the IPsec mode is fragmented. In relation to the encryption algorithm, an existing encryption algorithm is preferably designated using an identifier or the like rather than the algorithm itself being included as a parameter. For this reason, in a case where the encryption algorithm is designated as an SA parameter, an identifier specifying the encryption algorithm may be used as an SA parameter. In addition, an initiator cookie or a responder cookie is included in the ISAKMP_SA header of the initiator side or the responder side.

The volatile storage unit 3 temporarily stores the SA parameter set. In other words, the SA parameter set stored in the volatile storage unit 3 is automatically deleted when the printing device 1 is finished.

The nonvolatile storage unit 4 permanently preserves an SA deletion parameter set. The SA deletion parameter set is a part of the SA parameter set and is a group of parameters used to delete the SA.

The SA deletion parameter set according to the second embodiment includes at least the other party IP address, an ISAKMP_SA identifier (for example, a cookie), an encryption algorithm, an encryption key, and an IPsec_SA identifier (for example, an SPI). In addition, the other party IP address, the ISAKMP_SA identifier, and the encryption algorithm are SA parameters used for ISAKMP (hereinafter, referred to as an “ISAKMP_SA parameter”), and the IPsec_SA identifier is an SA parameter used for IPsec (hereinafter, referred to as an “IPsec_SA parameter”).

The encryption processing portion 5 encrypts the SA deletion parameter set. The encryption process is performed after the SA deletion parameter set is created and before the SA deletion parameter set is stored. In addition, an encryption algorithm used for the encryption process uses an algorithm different from the encryption algorithm related to the SA parameter set. A specific example of the encryption process method includes an encrypting file system (EFS).

In a case where the SA deletion parameter set stored in the nonvolatile storage unit 4 has been encrypted, the decryption processing portion 6 decrypts the SA deletion parameter set before creating an SA deletion notifying message. A decryption process method is preferably selected based on the encryption process method. In addition, the encryption processing portion 5 and the decryption processing portion 6 may be omitted.

The SA deletion notifying message creation portion 17 creates an SA deletion notifying message based on the SA deletion parameter set stored in the nonvolatile storage unit 4. The SA deletion notifying message is a message which is transmitted before new SA is rebuilt such that the SA parameter exchanging portion 2 requests the communication device 10 to delete the SA before the rebuilding. The SA deletion notifying message is created in some cases such as a case where the SA parameter set is preserved in the volatile storage unit 3 when the printing device 1 is normally finished, or a case where the SA parameter set is not preserved in the volatile storage unit 3 and the SA deletion parameter set is preserved in the nonvolatile storage unit 4 when the printing device 1 is reactivated after being suddenly finished. The transmission of the SA deletion notifying message is related to the exchange of SA parameters, and is thus performed by the SA parameter exchanging portion 2.

The SA parameter deletion portion 18 deletes the SA deletion parameter set before being rebuilt from the nonvolatile storage unit 4 after the SA deletion notifying message is transmitted.

Next, an SA establishment method of the printing device 1 according to the second embodiment will now be described.

The SA establishment method of the printing device 1 according to the second embodiment is realized by, for example, the printing device 1 according to the second embodiment. The SA establishment method of the printing device 1 includes an SA building step, a first storage step, an encryption processing step, a second storage step, a decryption processing step, an SA deletion notifying message creation step, and an SA parameter deletion step.

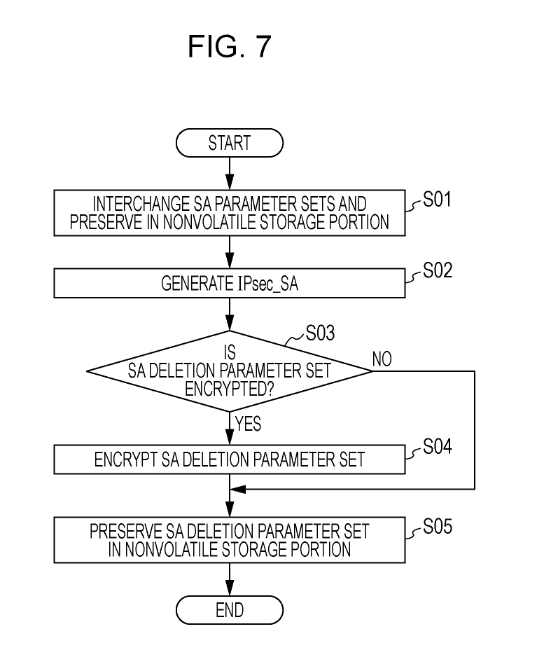

First, process procedures regarding preservation of an SA deletion parameter set in the printing device according to the second embodiment will be described with reference to FIGS. 6 and 7.

In the SA building step, as shown in FIGS. 6 and 7, SA is built between the communication device 10 and the printing device 1 by interchanging SA parameter sets (time T0 to time T1 in FIG. 6: exchange of IKE_SA parameters, and S01 to S02 in FIG. 7). In the same manner as the related art, the SA has the ISAKMP_SA of the phase 1 and the IPsec_SA of the phase 2, and the SA is established in this order.

In the first storage step, as shown in FIGS. 6 and 7, the SA parameter sets exchanged in the SA building step are temporarily stored in the volatile storage unit 3 provided in the printing device 1 (time T0 to time T1 in FIG. 6: exchange of IKE_SA parameters, and S01 in FIG. 7).

In the encryption process step, the encryption process is performed for the SA deletion parameter set which is a part of the SA parameter set and is used to delete the SA (S03 and S04 in FIG. 7). The encryption is performed after the SA deletion parameter set is created and before the SA deletion parameter set is stored. In addition, as shown in FIG. 7, if the encryption processing portion 5 is not installed in the printing device 1, the encryption process may not be performed (S03 to S05 in FIG. 7).

In the second storage step, as shown in FIGS. 6 and 7, the SA deletion parameter set is permanently stored in the nonvolatile storage unit 4 of the printing device 1 (time T1 in FIGS. 6, and S05 in FIG. 7). As shown in FIG. 6, the SA deletion parameter set includes at least the other party IP address, the ISAKMP_SA identifier, the encryption algorithm, and the encryption key, which are the ISAKMP_SA parameters, and the IPsec_SA identifier which is the IPsec_SA parameter.

If the IPsec_SA is generated, as shown in FIG. 6, printing related data is transmitted and received between the other party communication device 10 and the printing device 1 using IPsec packets via the IPsec_SA (time T1 to time T2: secure communication).

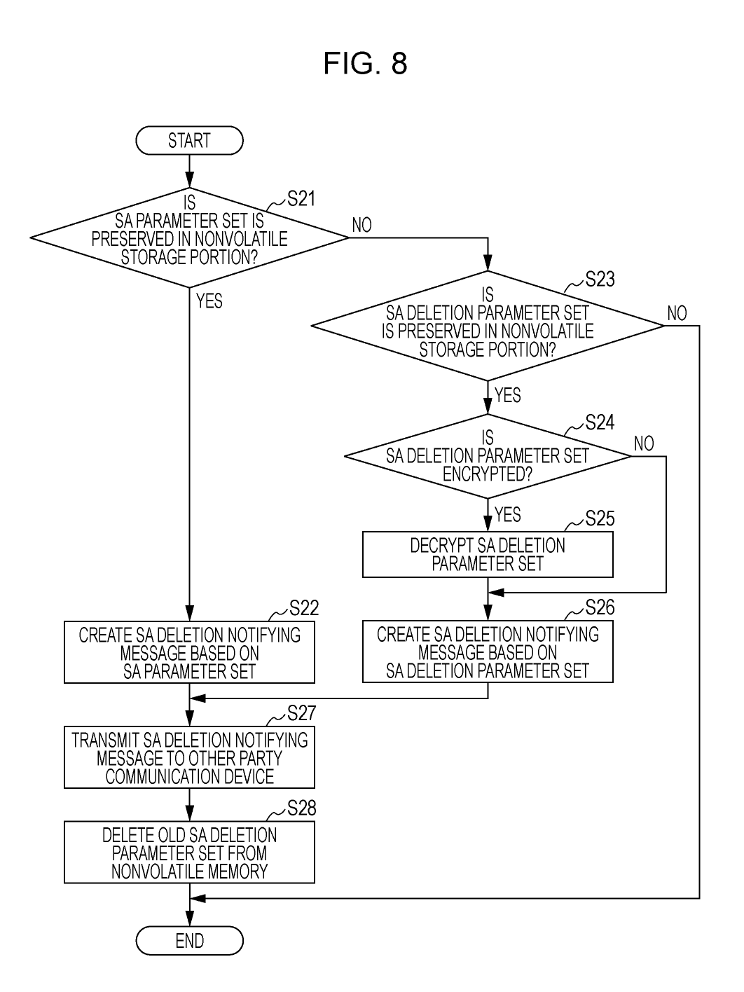

Next, referring to FIGS. 6 and 8, there will be made a description of process procedures regarding deletion of the SA in a normal state or the other states in the printing device according to the second embodiment. For example, in a case where the IPsec communication is normally finished, and in a case where the printing device is initialized, the SA deletion process flow shown in FIG. 8 is performed during the initialization process.

If the printing device 1 normally finishes the IPsec communication, as shown in FIG. 8, the SA parameter set is stored in the volatile storage unit 3 of the printing device 1 (S21), and an SA deletion notifying message is created based on the SA parameter set (S22).

However, as shown in FIG. 6, in a case where the printing device 1 is suddenly shutdown due to a certain unexpected cause such as a power failure during the IPsec communication (time T2), the SA parameter set stored in the volatile storage unit 3 of the printing device 1 is deleted, and thus the IPsec communication is disconnected (time T2 to time T3: power failure). For this reason, as shown in FIG. 6, when the printing device 1 is reactivated (time T3), a process shown in FIG. 8 is performed as a part of the initialization process of the printing device. In other words, when the SA parameter set is not stored in the volatile storage unit 3 of the printing device 1, it is checked whether or not the SA deletion parameter set is stored in the nonvolatile storage unit 4 (S21 to S23).

If the SA deletion parameter set is stored in the nonvolatile storage unit 4, it is further determined whether or not the SA deletion parameter set is encrypted, and if encrypted, the SA deletion parameter set is decrypted (S24 and S25).

In the SA deletion notifying message creation step, as shown in FIGS. 6 and 8, an SA deletion notifying message which is transmitted from the printing device 1 to the other party communication device 10 is created based on the SA deletion parameter set (time T3 to time T4 in FIG. 6: removal of old SA, and S26 in FIG. 8). In addition, when the SA deletion notifying message is created, the SA parameter exchanging portion 2 transmits the SA deletion notifying message to the other party communication device 10 (time T3 to time T4 in FIG. 6: removal of old SA, and S27 in FIG. 8).

In the SA parameter deletion step, the SA deletion notifying message is transmitted, and then the SA deletion parameter set before being rebuilt is deleted from the nonvolatile storage unit 4 (time T4 to time T5 in FIG. 6: exchange of IKE_SA parameters (SA rebuilding), and S28 in FIG. 8).

Next, operations and effects of the printing device 1 and the SA establishment method of the printing device 1 according to the second embodiment will be described.

In the printing device 1 and the SA establishment method of the printing device 1 according to the second embodiment, the SA deletion parameter set is permanently preserved in the nonvolatile storage unit 4, and, in a case where the SA parameter set is not preserved in the volatile storage unit 3 and the SA deletion parameter set is preserved in the nonvolatile storage unit 4, the SA deletion notifying message creation portion 17 creates an SA deletion notifying message based on the SA deletion parameter set, and the SA parameter exchanging portion 2 transmits the SA deletion notifying message to the other party communication device 10. For this reason, even if the printing device 1 is suddenly shutdown (disconnected) due to a power failure, SA can be promptly rebuilt after the printing device 1 is reactivated even before the term of SA validity.

In addition, in the printing device 1 and the SA establishment method of the printing device 1 according to the second embodiment, it is possible to realize transmission of the SA deletion notifying message and suppress a volume necessary for preservation in the nonvolatile storage unit 4 to the minimum by restricting a parameter set preserved in the nonvolatile storage unit 4 to the above-described SA deletion parameter set.

In addition, in the printing device 1 and the SA establishment method of the printing device 1 according to the second embodiment, the SA deletion notifying message is transmitted, and then the SA deletion parameter set before being rebuilt is deleted from the nonvolatile storage unit 4. For this reason, it is possible to suppress accumulation of old SA deletion parameter sets which are not necessary in terms of an SA deletion parameter set which is necessary to delete new SA.

Further, in the printing device 1 and the SA establishment method of the printing device 1 according to the second embodiment, the encryption process is performed when the SA deletion parameter set is preserved, and the decryption process is performed when the SA deletion notifying message is created. For this reason, by the use of, for example, a technique such as the encrypting file system (EFS), it is possible to prevent the malicious third party from hindering the IPsec communication even if the encryption key and other important parameters included in the SA deletion parameter set are leaked.

In other words, according to the printing device and the SA establishment method of the printing device of the second embodiment, it is possible to secure communication safety between devices and achieve an effect that the IPsec communication can be promptly restarted since various operations such as being capable of transmitting the SA deletion notifying message after the printing device is reactivated.

In addition, the invention is not limited to the above-described embodiments, and can be variously modified as necessary.

The entire disclosure of Japanese Patent Application No.2011-031720, filed Feb. 17, 2011 and 2011-036815, filed Feb. 23, 2011 are expressly incorporated by reference herein.

What is claimed is:

1. A communication system comprising:
a communication device and a printing device performing IPsec communication,
wherein both the devices include
an SA parameter exchanging portion that builds and deletes SA (Security Association) which is a secure virtual communication path by exchanging SA parameter sets which are various parameters for performing the IPsec communication with the other party device; and
a nonvolatile storage portion that stores at least a part of information for the SA parameter set, and
wherein, in a case where the printing device is initialized, the printing device has a message transmission portion that transmits a predetermined message to the communication device if the part of information is stored in the nonvolatile storage portion, and the communication device deletes information for performing IPsec communication with the printing device from the nonvolatile storage portion of the communication device in response to reception of the predetermined message.

2. The communication system according to claim 1, wherein the part of information stored in the nonvolatile storage portion of the printing device includes an IP address of the communication device included in an SA parameter set, and an SA deletion parameter set used to delete the SA, and
wherein, if the SA deletion parameter set is stored in the nonvolatile storage portion of the printing device, the message transmission portion of the printing device creates an SA deletion notifying message for requesting deletion of the SA based on the SA deletion parameter set, and transmits the SA deletion notifying message to the communication device as the predetermined message.

3. The communication system according to claim 2, wherein the SA deletion parameter set includes at least the other party IP address, an ISAKMP_SA identifier, an encryption algorithm, and an encryption key, which are ISAKMP_SA parameters, and an IPsec_SA identifier which is an IPsec_SA parameter.

4. The communication system according to claim 2, wherein the printing device further includes an SA deletion parameter deleting portion that deletes the SA deletion parameter set from the nonvolatile storage portion of the printing device after the SA deletion notifying message is transmitted.

5. The communication system according to claim 1, wherein the part of information stored in the nonvolatile storage portion of the printing device includes an IP address of the communication device included in an SA parameter set, and
wherein, if the IP address of the communication device is stored in the nonvolatile storage unit of the printing device, the message transmission portion of the printing device creates an activation message including the IP address of the communication device stored in the nonvolatile storage portion and an IP address of the printing device, and transmits the activation message to the communication device as the predetermined message.

6. The communication system according to claim 5, wherein the communication device further includes an SA parameter deletion portion (agent) that deletes the SA parameter set related to the IPsec communication with the printing device in response to reception of the activation message.

7. The communication system according to claim 5, wherein the printing device further includes an IP address deletion portion that deletes the IP address of the communication device from the nonvolatile storage portion of the printing device after transmitting the activation message.

8. A printing device which performs IPsec communication with a communication device, comprising:
an SA parameter exchanging portion that builds and deletes SA (Security Association) which is a secure virtual communication path by exchanging SA parameter sets which are various parameters for performing the IPsec communication with the communication device; and
a nonvolatile storage portion that stores at least a part of information for the SA parameter set,
wherein, in a case where the printing device is initialized, the printing device has a message transmission portion that transmits a predetermined message to the communication device so as to request the communication device to delete information of the communication device for performing IPsec communication if the part of information is stored in the nonvolatile storage portion.

9. The printing device according to claim 8, wherein the part of information stored in the nonvolatile storage portion of the printing device includes an IP address of the communication device included in the SA parameter set, and an SA deletion parameter set used to delete the SA, and
wherein, if the SA deletion parameter set is stored in the nonvolatile storage portion, the message transmission portion creates an SA deletion notifying message for requesting deletion of the SA based on the SA deletion parameter set stored in the nonvolatile storage portion, and transmits the SA deletion notifying message to the communication device as a predetermined message.

10. The printing device according to claim 9, wherein the SA deletion parameter set includes at least the other party IP address, an ISAKMP_SA identifier, an encryption algorithm, and an encryption key, which are ISAKMP_SA parameters, and an IPsec_SA identifier which is an IPsec_SA parameter.

11. The printing device according to claim 9, further comprising an SA deletion parameter deleting portion that deletes the SA deletion parameter set from the nonvolatile storage portion after the SA deletion notifying message is transmitted.

12. The printing device according to claim 8, wherein the part of information stored in the nonvolatile storage portion of the printing device includes an IP address of the communication device included in an SA parameter set, and
wherein, if the IP address of the communication device is stored in the nonvolatile storage portion of the printing device, the message transmission portion of the printing device creates an activation message including the IP address of the communication device stored in the nonvolatile storage portion and an IP address of the printing device, and transmits the activation message to the communication device as a predetermined message.

13. An SA establishment method for establishing SA (Security Association) which is a secure virtual communication path in order to perform IPsec communication between a communication device and a printing device,
where both the communication device and the printing device exchange SA parameter sets which are various parameters for performing IPsec communication with other party device, and respectively include a nonvolatile storage portion that stores at least a part of information for the SA parameter set, the method comprising:
determining whether or not the part of information is stored in the nonvolatile storage portion of the printing device if the printing device is initialized;
transmitting a predetermined message to the communication device if it is determined that the part of information is stored;
determining whether or not the communication device receives the predetermined message; and
deleting information for performing IPsec communication with the printing device from the nonvolatile storage portion of the communication device according to a determination that the communication device receives the predetermined message.
